(19) United States
(12) Patent Application Publication
(10) Pub. No.: US 2024/0405501 A1
(43) Pub. Date: Dec. 5, 2024

(54) GAS LASER DEVICE AND ELECTRONIC DEVICE MANUFACTURING METHOD

(71) Applicant: Gigaphoton Inc., Tochigi (JP)

(72) Inventors: Youichi YAMANOUCHI, Oyama-shi (JP); Hiroshi UMEDA, Oyama-shi (JP); Takeshi UEYAMA, Oyama-shi (JP)

(73) Assignee: Gigaphoton Inc., Tochigi (JP)

(21) Appl. No.: 18/799,432

(22) Filed: Aug. 9, 2024

Related U.S. Application Data
(63) Continuation of application No. PCT/JP2022/013639, filed on Mar. 23, 2022.

(51) Int. Cl. H01S 3/0975; H01S 3/097

(52) U.S. Cl. CPC H01S 3/0975; H01S 3/09702

(57) ABSTRACT

A gas laser device includes a chamber configured to enclose a laser gas as including a pair of discharge electrodes having a longitudinal direction oriented along a predetermined direction and facing each other with a space therebetween; a plurality of capacitors arranged along the predetermined direction, each of the capacitors having one terminal electrically connected to one of the discharge electrodes and the other terminal electrically connected to the other of the discharge electrodes; and first and second magnetic switches each electrically connected to the one discharge electrode and the one terminal of each of the capacitors and electrically connected to each other in parallel. The second magnetic switch is arranged closer to a center of the one discharge electrode in the predetermined direction than the first magnetic switch, and a Vt product of the first magnetic switch is smaller than a Vt product of the second magnetic switch.

### CROSS-REFERENCE TO RELATED APPLICATIONS

The present application claims the benefit of International Application No. PCT/JP2022/013639, filed on Mar. 23, 2022, the entire contents of which are hereby incorporated by reference.

### BACKGROUND

### 1. Technical Field

The present disclosure relates to a gas laser device and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 pm to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: Japanese Patent Application No. S63-9185

Patent Document 2: Japanese Patent Application No. 2003-124550

### SUMMARY

A gas laser device according to an aspect of the present disclosure includes a chamber configured to enclose a laser gas as including a pair of discharge electrodes having a longitudinal direction oriented along a predetermined direction and facing each other with a space therebetween; a plurality of capacitors arranged along the predetermined direction, each of the capacitors having one terminal electrically connected to one of the discharge electrodes and the other terminal electrically connected to the other of the discharge electrodes; and a first magnetic switch and a second magnetic switch each electrically connected to the one discharge electrode and the one terminal of each of the capacitors and electrically connected to each other in parallel. Here, the second magnetic switch is arranged closer to a center of the one discharge electrode in the predetermined direction than the first magnetic switch, and a Vt product of the first magnetic switch is smaller than a Vt product of the second magnetic switch.

An electronic device manufacturing method according to an aspect of the present disclosure includes generating laser light using a gas laser device, outputting the laser light to an exposure apparatus, and exposing a photosensitive substrate to the laser light in the exposure apparatus to manufacture an electronic device. Here, the gas laser device includes a chamber configured to enclose a laser gas as including a pair of discharge electrodes having a longitudinal direction oriented along a predetermined direction and facing each other with a space therebetween; a plurality of capacitors arranged along the predetermined direction, each of the capacitors having one terminal electrically connected to one of the discharge electrodes and the other terminal electrically connected to the other of the discharge electrodes; and a first magnetic switch and a second magnetic switch each electrically connected to the one discharge electrode and the one terminal of each of the capacitors and electrically connected to each other in parallel. The second magnetic switch is arranged closer to a center of the one discharge electrode in the predetermined direction than the first magnetic switch, and a Vt product of the first magnetic switch is smaller than a Vt product of the second magnetic switch.

### BRIEF DESCRIPTION OF THE DRAWINGS

Embodiments of the present disclosure will be described below merely as examples with reference to the accompanying drawings.

FIG. 1 is a schematic view showing a schematic configuration example of an entire electronic device manufacturing apparatus.

FIG. 2 is a schematic view showing a schematic configuration example of an entire gas laser device of a comparative example.

FIG. 3 is a sectional view, perpendicular to a travel direction of laser light, of a chamber of the comparative example.

FIG. 4 is a view showing the configuration of a part of a circuit of the comparative example as viewed from above.

FIG. 5 is an electrical circuit diagram of the gas laser device of the comparative example.

FIG. 6 is a graph showing temporal changes in the potential of one discharge electrode.

FIG. 7 is a view showing the configuration of a part of a circuit of a first embodiment in a similar manner as in FIG. 4.

FIG. 8 is a view showing the configuration from the one discharge electrode to a connection plate of the first embodiment from a same viewpoint as in FIG. 2.

FIG. 9 is a graph showing temporal changes in the potential of the one discharge electrode when Vt products of a first magnetic switch, a second magnetic switch, and a third magnetic switch are the same as each other in the first embodiment.

FIG. 10 is a graph showing temporal changes in the potential of the one discharge electrode in the first embodiment.

FIG. 11 is a view showing the configuration of a part of the circuit of a second embodiment in a similar manner as in FIG. 4.

FIG. 12 is a view showing the configuration from the one discharge electrode to the connection plate of the second embodiment from a same viewpoint as in FIG. 2.

FIG. 13 is a view showing the configuration from the one discharge electrode to a magnetic switch of a third embodiment from a same viewpoint as in FIG. 2.

FIG. 14 is a view showing a core serving as each of a first core, a second core, and a third core of a fourth embodiment.

FIG. 15 is a view showing the configuration of a part of the circuit of a fifth embodiment in a similar manner as in FIG. 4.

FIG. 16 is a view showing the configuration of a part of the circuit of a sixth embodiment in a similar manner as in FIG. 4.

FIG. 17 is a view showing the configuration of a part of the circuit of a seventh embodiment in a similar manner as in FIG. 4.

### DESCRIPTION OF EMBODIMENTS

1. Description of electronic device manufacturing apparatus used in exposure process for electronic device
2. Description of gas laser device of comparative example
   2.1 Configuration
   2.2 Operation
   2.3 Problem
3. Description of gas laser device of first embodiment
   3.1 Configuration
   3.2 Operation
   3.3 Effect
4. Description of gas laser device of second embodiment
   4.1 Configuration
   4.2 Effect
5. Description of gas laser device of third embodiment
   5.1 Configuration
   5.2 Effect
6. Description of gas laser device of fourth embodiment
   6.1 Configuration
   6.2 Effect
7. Description of gas laser device of fifth embodiment
   7.1 Configuration
   7.2 Effect
8. Description of gas laser device of sixth embodiment
   8.1 Configuration
   8.2 Effect
9. Description of gas laser device of seventh embodiment
   9.1 Configuration
   9.2 Effect

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Description of Electronic Device Manufacturing Apparatus Used in Exposure Process for Electronic Device

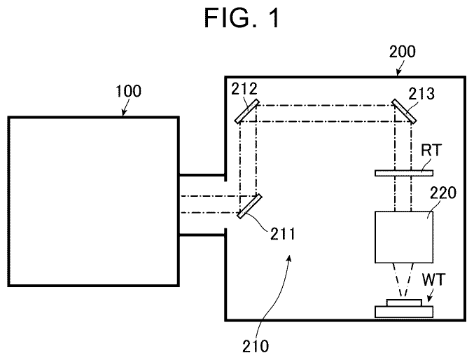

FIG. 1 is a schematic view showing a schematic configuration example of an entire electronic device manufacturing apparatus used in an exposure process for an electronic device. As shown in FIG. 1, the manufacturing apparatus used in the exposure process includes a gas laser device 100 and an exposure apparatus 200. The exposure apparatus 200 includes an illumination optical system 210 including a plurality of mirrors 211, 212, 213 and a projection optical system 220. The illumination optical system 210 illuminates a reticle pattern of a reticle stage RT with laser light incident from the gas laser device 100. The projection optical system 220 causes the laser light transmitted through the reticle to be imaged as being reduced and projected on a workpiece (not shown) arranged on a workpiece table WT. The workpiece is a photosensitive substrate such as a semiconductor wafer on which photoresist is applied. The exposure apparatus 200 synchronously translates the reticle stage RT and the workpiece table WT to expose the workpiece to the laser light reflecting the reticle pattern. Through the exposure process as described above, a device pattern is transferred onto the semiconductor wafer, thereby a semiconductor device, which is an electronic device, can be manufactured.

### 2. Description of Gas Laser Device of Comparative Example

### 2.1 Configuration

The gas laser device 100 of a comparative example will be described. The comparative example of the present disclosure is an example recognized by the applicant as known only by the applicant, and is not a publicly known example admitted by the applicant.

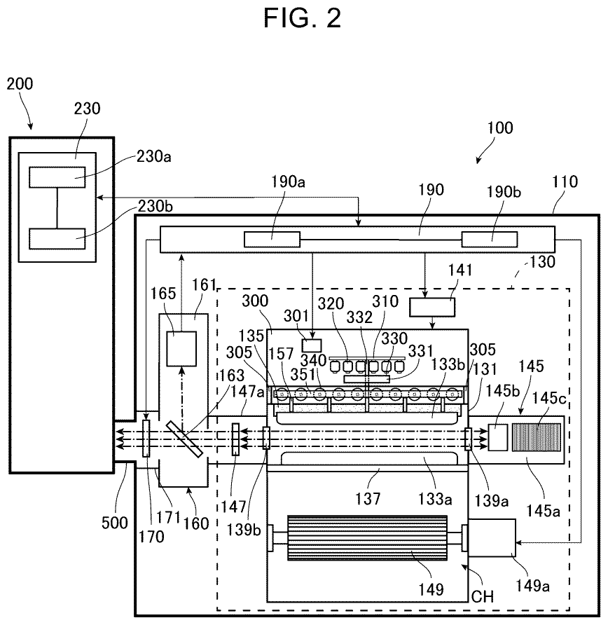

FIG. 2 is a schematic view showing a schematic configuration example of the entire gas laser device 100 of the comparative example. The gas laser device 100 is, for example, an ArF excimer laser device using a mixed gas including argon (Ar), fluorine (F₂), and neon (Ne). The gas laser device 100 outputs laser light having a center wavelength of about 193 nm. Here, the gas laser device 100 may be a gas laser device other than the ArF excimer laser device, and may be, for example, a KrF excimer laser device using a mixed gas including krypton (Kr), F₂, and Ne. In this case, the gas laser device 100 outputs laser light having a center wavelength of about 248 nm. The mixed gas containing Ar, F₂, and Ne which is a laser medium and the mixed gas containing Kr, F₂, and Ne which is a laser medium may be each referred to as a laser gas. FIG. 2 shows the internal configuration of a chamber device CH in a cross-sectional view along the travel direction of the laser light. Along the travel direction of the laser light, the left side, the right side, the upper side, and the lower side in the drawing is referred to as a front side, a rear side, an upper side, and a lower side, respectively.

The gas laser device 100 includes a housing 110, and a laser oscillator 130, a monitor module 160, a shutter 170, and a laser device processor 190 arranged at the internal space of the housing 110 as a main configuration.

The laser oscillator 130 includes the chamber device CH, a charger 141, a line narrowing module 145, an output coupling mirror 147, and a pulse compression circuit 300.

Examples of the material of a chamber 131 of the chamber device CH include a metal such as nickel-plated aluminum and nickel-plated stainless steel. The chamber 131 includes an internal space in which light is generated by excitation of a laser medium in the laser gas. The laser gas is supplied from a laser gas supply source (not shown) to the internal space of the chamber 131 through a pipe (not shown). Further, the laser gas in the chamber 131 is subjected to a process such as removing Fe gas by a halogen filter, and is exhausted to the housing 110 through a pipe (not shown) by an exhaust pump (not shown).

At the internal space of the chamber 131, an electrode 133a which is a first main electrode and an electrode 133b which is a second main electrode are arranged to face each other with a space therebetween, and each have a longitudinal direction along a predetermined direction which is the travel direction of the laser light. In the present example, the electrode 133b is located directly above the electrode 133a. The electrodes 133a, 1 133b are discharge electrodes for exciting the laser medium by glow discharge. In the present example, the electrode 133a is the anode and the electrode 133b is the cathode.

The electrode 133a is supported by and electrically connected to an electrode holder portion 137. The electrode 133b is fixed to a surface of a plate-shaped electrical insulating portion 135 on a side facing the internal space of the chamber 131 by a current introduction terminal 157 which is, for example, a bolt. The current introduction terminal 157 is electrically connected to the pulse compression circuit 300 and other circuit components which will be described later, and ensures conduction between the pulse compression circuit 300 and the electrode 133b.

The electrical insulating portion 135 includes an insulator. Examples of the material of the electrical insulating portion 135 include alumina ceramics having low reactivity with an F₂ gas. The electrical insulating portion 135 may have electrical insulation, and the material of the electrical insulating portion 135 may be a resin such as a phenol resin and a fluoro-resin, quartz, glass, or the like. The electrical insulating portion 135 blocks an opening provided in the chamber 131 and is fixed to the chamber 131.

The charger 141 is a DC high voltage power source that supplies electric energy to the pulse compression circuit 300 described later. The pulse compression circuit 300 is arranged on the holder 305, generates a pulse high voltage from the electric energy held in the charger 141, and applies the high voltage between the electrode 133a and the electrode 133b.

When the high voltage is applied between the electrode 133a and the electrode 133b, discharge occurs between the electrode 133a and the electrode 133b. The laser medium in the chamber 131 is excited by the energy of the discharge, and the excited laser medium emits light when shifting to the ground state.

A pair of windows 139a, 139b are arranged on a wall surface of the chamber 131. The window 139a is located at one end side of the chamber 131 in the travel direction of the laser light, the window 139b is located at the other end side in the travel direction, and the windows 139a, 139b sandwich a space between the electrode 133a and the electrode 133b. The windows 139a, 139b are inclined at the Brewster angle with respect to the travel direction of the laser light so that reflection of the laser light is suppressed. The laser light oscillated as described later is output to the outside of the chamber 131 through the windows 139a, 139b. Since a pulse high voltage is applied between the electrode 133a and the electrode 133b by the pulse compression circuit 300 as described above, the laser light is pulse laser light.

The line narrowing module 145 includes a housing 145a, and a prism 145b, a grating 145c, and a rotation stage (not shown) arranged at the internal space of the housing 145a. An opening is formed in the housing 145a, and the housing 145a is connected to the rear side of the chamber 131 through the opening.

The prism 145b expands the beam width of the light output from the window 139a and causes the light to be incident on the grating 145c. Further, the prism 145b also reduces the beam width of the reflection light from the grating 145c and returns the light to the internal space of the chamber 131 through the window 139a. The prism 145b is supported by the rotation stage and is rotated by the rotation stage. By the rotation of the prism 145b, the incident angle of the light with respect to the grating 145c is changed, and the wavelength of the light returning from the grating 145c to the chamber 131 via the prism 145b can be selected. Although FIG. 2 shows an example in which one prism 145b is arranged, at least one prism may be arranged.

The surface of the grating 145c is configured of a material having a high reflectance, and a large number of grooves are formed on the surface at predetermined intervals. The cross-sectional shape of each groove is, for example, a right triangle. The light incident on the grating 145c from the prism 145b is diffracted in a direction corresponding to the wavelength thereof when reflected by the grooves. The grating 145c is arranged in the Littrow arrangement, which causes the incident angle of the light incident on the grating 145c from the prism 145b to coincide with the diffraction angle of the diffracted light having a desired wavelength. Thus, light having a wavelength close to the desired wavelength returns into the chamber 131 via the prism 145b.

The output coupling mirror 147 is arranged at the internal space of an optical path pipe 147a connected to the front side of the chamber 131, and faces the window 139b. The output coupling mirror 147 transmits a part of the laser light output from the window 139b toward the monitor module 160, and reflects another part of the laser light to return to the internal space of the chamber 131 through the window 139b. Thus, the grating 145c and the output coupling mirror 147 configure a Fabry-Perot laser resonator.

The monitor module 160 is arranged on the optical path of the laser light output from the output coupling mirror 147. The monitor module 160 includes a housing 161, and a beam splitter 163 and an optical sensor 165 arranged at the internal space of the housing 161. An opening is formed in the housing 161, and the internal space of the housing 161 communicates with the internal space of the optical path pipe 147a through the opening.

The beam splitter 163 transmits a part of the laser light output from the output coupling mirror 147 toward the shutter 170, and reflects another part of the laser light toward a light receiving surface of the optical sensor 165. The optical sensor 165 outputs a signal indicating an energy E of the laser light incident on the light receiving surface to the laser device processor 190.

The laser device processor 190 of the present disclosure is a processing device including a storage device 190a in which a control program is stored and a central processing unit (CPU) 190b that executes the control program. The laser device processor 190 is specially configured or programmed to perform various processes included in the present disclosure. The laser device processor 190 controls the entire gas laser device 100.

The laser device processor 190 transmits and receives various signals to and from an exposure apparatus processor 230 of the exposure apparatus 200. For example, the laser device processor 190 receives signals indicating a later-described light emission trigger Tr, a later-described target energy Et, and the like from the exposure apparatus processor 230. The target energy Et is a target value of the energy of the laser light used in the exposure process. The laser device processor 190 controls the charge voltage of the charger 141 based on the energy E and the target energy Et received from the optical sensor 165 and the exposure apparatus processor 230, respectively. By controlling the charge voltage, the energy of the laser light is controlled. The laser device processor 190 is electrically connected to the shutter 170 and controls opening and closing of the shutter 170.

The laser device processor 190 closes the shutter 170 until a difference ΔE between the energy E received from the monitor module 160 and the target energy Et received from the exposure apparatus processor 230 falls within an allowable range. Further, when the difference ΔE falls within the allowable range, the laser device processor 190 transmits, to the exposure apparatus processor 230, a reception preparation completion signal indicating that reception preparation of the light emission trigger Tr is completed. The exposure apparatus processor 230 transmits a signal indicating the light emission trigger Tr to the laser device processor 190 when receiving the reception preparation completion signal, and the laser device processor 190 opens the shutter 170 when receiving the signal indicating the light emission trigger Tr. The light emission trigger Tr is a timing signal for the exposure apparatus processor 230 to cause the laser oscillator 130 to perform laser oscillation, and is an external trigger. The light emission trigger Tr is defined by a predetermined repetition frequency f and a predetermined number of pulses P of the laser light. The repetition frequency f of the laser light is, for example, 100 Hz or more and 10 kHz or less.

The shutter 170 is arranged on the optical path at the internal space of an optical path pipe 171 communicating with an opening formed at the housing 161 of the monitor module 160 on a side opposite to the side to which the optical path pipe 147a is connected. The internal spaces of the optical path pipes 171, 147a and the internal spaces of the housings 161, 145a are supplied and filled with a purge gas. The purge gas includes an inert gas such as nitrogen (N₂). The purge gas is supplied from a purge gas supply source (not shown) through a pipe (not shown). The optical path pipe 171 is in communication with the exposure apparatus 200 through the opening of the housing 110 and the optical path pipe 500 connecting the housing 110 and the exposure apparatus 200. The laser light having passed through the shutter 170 enters the exposure apparatus 200.

The exposure apparatus processor 230 of the present disclosure is a processing device including a storage device 230a in which a control program is stored and a CPU 230b that executes the control program. The exposure apparatus processor 230 is specifically configured or programmed to perform various processes included in the present disclosure. Further, the exposure apparatus processor 230 controls the entire exposure apparatus 200.

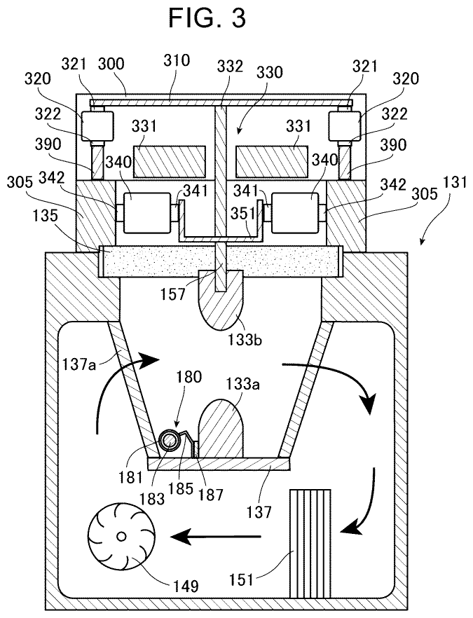

FIG. 3 is a sectional view, perpendicular to the travel direction of the laser light, of the chamber 131 of the comparative example. A cross flow fan 149 and a heat exchanger 151 are further arranged at the internal space of the chamber 131.

The cross flow fan 149 and the heat exchanger 151 are arranged on a side opposite to the electrode 133a with respect to the electrode holder portion 137. The space of the chamber 131 at which the cross flow fan 149 and the heat exchanger 151 are arranged is in communication with the space between the electrode 133a and the electrode 133b. The heat exchanger 151 is a radiator arranged beside the cross flow fan 149 and connected to a pipe (not shown) through which a cooling medium flows. As shown in FIG. 2, the cross flow fan 149 is connected to a motor 149a arranged outside the chamber 131, and rotates with rotation of the motor 149a. As the cross flow fan 149 rotates, the laser gas enclosed at the internal space of the chamber 131 circulates as indicated by arrows in FIG. 3. At least a part of the circulating laser gas passes through the heat exchanger 151, so that the temperature of the laser gas is adjusted.

The electrode holder portion 137 is electrically connected to the chamber 131 via wirings 137a. The electrode 133a supported by the electrode holder portion 137 is electrically connected to the ground via the electrode holder portion 137, the wirings 137a, and the chamber 131. Further, the chamber 131 is electrically connected to the holder 305, and the holder 305 is electrically connected to the ground.

A preionization electrode 180 is provided on the electrode holder portion 137 beside the electrode 133a. The preionization electrode 180 includes a dielectric pipe 181, a preionization inner electrode 183, and a preionization outer electrode 185.

The dielectric pipe 181 is, for example, a cylindrical pipe whose longitudinal direction is arranged along a predetermined direction. The dielectric pipe 181 is made of, for example, alumina ceramics or sapphire. The preionization inner electrode 183 has a rod shape, is arranged inside the dielectric pipe 181, and extends along the longitudinal direction of the dielectric pipe 181. The preionization inner electrode 183 is made of, for example, copper or brass. The preionization outer electrode 185 is arranged between the dielectric pipe 181 and the electrode 133a, and extends along the longitudinal direction of the dielectric pipe 181. An end portion of the preionization outer electrode 185 is in contact with the outer circumference surface of the dielectric pipe 181. Here, at least a part of the end portion of the preionization outer electrode 185 may not be in contact with the outer circumference surface of the dielectric pipe 181 as long as corona discharge described later occurs. The preionization outer electrode 185 is fixed to a spacer 187 which is fixed to the electrode 133a.

The preionization inner electrode 183 is electrically connected to the pulse compression circuit 300 via preionization capacitor 188 in shown FIG. 5. The preionization outer electrode 185 is electrically connected to the electrode 133a via the electrode holder portion 137, and is electrically connected to the chamber 131 via the electrode holder portion 137 and the wirings 137a. Therefore, the preionization outer electrode 185 electrically connected to the ground. When a high voltage is applied from the pulse compression circuit 300 to the preionization inner electrode 183 and the preionization outer electrode 185, corona discharge occurs in the vicinity of an end portion of the preionization outer electrode 185. The corona discharge assists stable generation of glow discharge which occurs between the electrodes 133a, 133b.

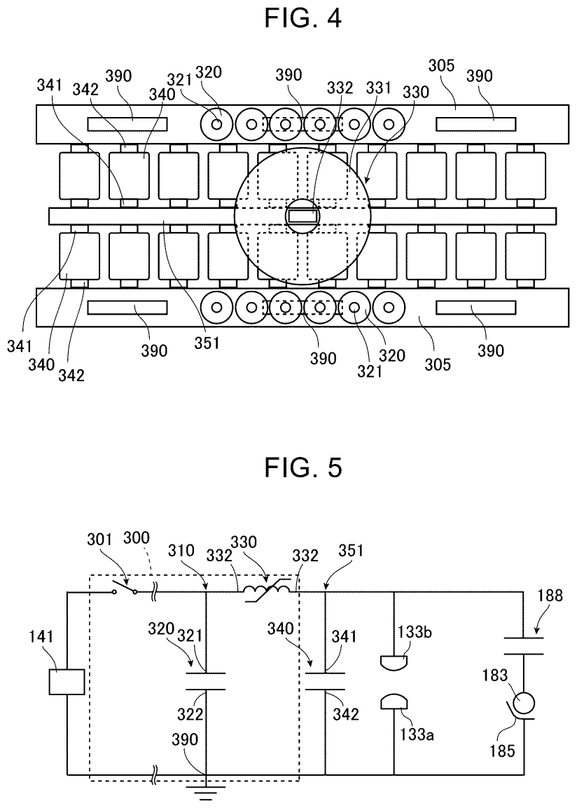

Next, the configuration of the pulse compression circuit 300 and the configuration of a circuit between the pulse compression circuit 300 and the electrodes 133a, 133b will be described. FIG. 4 is a view showing the configuration of a part of the circuit from the charger 141 to the electrodes 133b, 133b as viewed from above. FIG. 5 is an electrical circuit diagram of the gas laser device 100 of the present example.

As shown in FIGS. 2 to 5, the pulse compression circuit 300 includes a switch 301, a plurality of capacitors 320, a magnetic switch 330, and a connection plate 310 as a main configuration. Further, the circuit between the pulse compression circuit 300 and the electrodes 133a, 133b mainly includes a plurality of peaking capacitors 340, a connection plate 351, and the above-described current introduction terminal 157 as a main configuration. In FIG. 5, the plurality of capacitors 320 and the plurality of peaking capacitors 340 are collectively represented by one symbol, respectively.

The switch 301 is electrically connected to the charger 141 and is controlled by the laser device processor 190. The connection plate 310 is a conductive plate and is configured such that, when the switch 301 is turned ON from OFF, the electric energy from the charger 141 is supplied to the pulse compression circuit 300 via the connection plate 310. Accordingly, when the switch 301 is turned ON from OFF, a current flows to the connection plate 310. The connection plate 310 and the switch 301 may be connected to a wiring or the like, and may be insulated by a transformer or the like.

One terminal 321 of each capacitor 320 is electrically connected to the connection plate 310. The other terminal 322 of each capacitor 320 is electrically connected to a ground terminal 390 connected to the ground via the holder 305. Accordingly, the respective capacitors 320 are electrically connected in parallel. In FIG. 2, the ground terminal 390 is omitted. The capacitor 320 is, for example, a ceramic capacitor whose material of a dielectric is strontium titanate or the like. Examples of other materials of the dielectric include barium titanate. In the present example, as shown in FIG. 4, when the pulse compression circuit 300 is viewed from above, one half of the capacitors 320 is arranged on one side of the electrode 133b and the other half of the capacitors 320 is arranged on the other side of the electrode 133b in a direction perpendicular to the predetermined direction that is the longitudinal direction of the electrode 133b. Each of the one half of the capacitors 320 and the other half of the capacitors 320 is aligned along the predetermined direction in the vicinity of the center of the electrode 133b along the predetermined direction.

The magnetic switch 330 is located directly above the electrode 133b and at the center of the electrode 133b in the predetermined direction. The magnetic switch 330 includes a core 331 and a conductor 332. The core 331 is made of a rotationally symmetric ring-shaped magnetic material. The core 331 is arranged such that the axis of the ring extends along the direction in which the electrode 133a and the electrode 133b are aligned. Examples of the ring-shaped magnetic material include ferrite formed in a ring shape and a laminated body of ring-shaped silicon steel plates. The conductor 332 is a rod-shaped conductor in the present example, and one end of the conductor 332 is electrically connected to the connection plate 310. The conductor 332 is inserted into the core 331, and the other end of the conductor 332 is electrically connected to the connection plate 351. Here, the conductor 332 may be wound around the core 331.

The connection plate 351 is a conductive plate arranged between the electrode 133b and the magnetic switch 330 with the longitudinal direction thereof arranged along the predetermined direction. As shown in FIG. 3, the cross section of the connection plate 351 perpendicular to the longitudinal direction is generally U-shaped, and both end portions thereof are bent toward the magnetic switch 330. The conductor 332 of the magnetic switch 330 and the connection plate 351 are connected to each other at the substantially center in the longitudinal direction of the connection plate 351.

One terminal 341 of each peaking capacitor 340 is electrically connected to the connection plate 351. The peaking capacitor 340 has a configuration similar to that of the capacitor 320, for example. Here, the peaking capacitor 340 may have a configuration different from that of the capacitor 320, and the capacitance of the peaking capacitor 340 and the capacitance of the capacitor 320 may be the same as or different from each other. The other terminal 342 of each peaking capacitor 340 is electrically connected to the holder 305 5 that is electrically connected to the ground terminal 390. The other terminal 342 of each peaking capacitor 340 is electrically connected to the other electrode 133a via the holder 305. Thus, the peaking capacitors 340 are electrically connected in parallel. In the present example, as shown in FIG. 4, when the pulse compression circuit 300 is viewed from above, in a direction perpendicular to the predetermined direction, one half of the peaking capacitors 340 is arranged on one side of the electrode 133b and the other half of the peaking capacitors 340 is arranged on the other side of the electrode 133b. Further, each of the one half of the peaking capacitors 340 and the other half of the peaking capacitors 340 is aligned along the predetermined direction.

The current introduction terminal 157 is electrically connected to a surface of the connection plate 351 opposite to the surface to which the conductor 332 is connected. Therefore, one terminal of each of the peaking capacitors 340 is electrically connected to one electrode 133b. In the present example, one current introduction terminal 157 is arranged directly below the conductor 332, and two current introduction terminals are 157 arranged along the longitudinal direction of the connection plate 351 so as to sandwich the current introduction terminal 157. Therefore, in the present example, a total of five current introduction terminals 157 are arranged. As described above, each of the current introduction terminals 157 is electrically connected to the electrode 133b.

Further, the preionization inner electrode 183 is electrically connected to the connection plate 351 via the preionization capacitor 188, and the preionization outer electrode 185 is connected to the ground.

### 2.2 Operation

Next, operation of the gas laser device 100 of the comparative example will be described.

Before the gas laser device 100 outputs the laser light, the internal spaces of the optical path pipes 147a, 171, 500 and the internal spaces of the housings 145a, 161 are filled with a purge gas from the purge gas supply source (not shown). Further, a laser gas is supplied to the internal space of the chamber 131 from the laser gas supply source (not shown). When the laser gas is supplied, the laser device processor 190 controls the motor 149a to rotate the cross flow fan 149. By the rotation of the cross flow fan 149, the laser gas circulates through the internal space of the chamber 131.

Before the gas laser device 100 outputs the laser light, the laser device processor 190 receives a signal indicating the target energy Et and a signal indicating the light emission trigger Tr from the exposure apparatus processor 230. Upon receiving the signal indicating the target energy Et, the laser device processor 190 closes the shutter 170 and drives the charger 141. Further, the laser device processor 190 turns ON the switch 301 of the pulse compression circuit 300. Accordingly, the current from the charger 141 flows to the capacitor 320 via the connection plate 310, and the capacitor 320 is charged. The current from the charger 141 also tends to flow to the conductor 332 of the magnetic switch 330 via the connection plate 310. However, since the magnetic flux density of the core 331 increases due to the current flowing to the conductor 332, the current hardly flows to the conductor 332 due to the back electromotive force caused by the change in the magnetic flux of the core 331. When the magnetic flux density of the core 331 becomes close to saturation, the amount of change in the magnetic flux of the core 331 decreases, and the current from the charger 141 is charged to the peaking capacitor 340 via the connection plate 351. At this time, a current flows from the capacitor 320 to the peaking capacitor 340, and the peaking capacitor 340 is charged to a high potential in a short time. Then, a pulse high voltage is applied from the charger 141 and the peaking capacitor 340 to the electrode 133b via the current introduction terminal 157 in a short time. Here, the timing at which the high voltage is applied between the preionization inner electrode 183 and the preionization outer electrode 185 is slightly earlier than the timing at which the high voltage is applied between the electrode 133a and the electrode 133b. When the high voltage is applied between the preionization inner electrode 183 and the preionization outer electrode 185, corona discharge occurs in the vicinity of the dielectric pipe 181 and the end portion of the preionization outer electrode 185, and ultraviolet light is emitted. When the laser gas between the electrode 133a and the electrode 133b is irradiated with the ultraviolet light, the laser gas between the electrode 133a and the electrode 133b undergoes preionization. After the preionization, when the high voltage is applied between the electrode 133a and the electrode 133b as described above, main discharge occurs between the electrode 133a and the electrode 133b.

By the main discharge, the laser medium contained in the laser gas between the electrode 133a and the electrode 133b is brought into an excited state, and light is emitted when the laser medium returns to the ground state. The light resonates between the grating 145c and the output coupling mirror 147, and is amplified every time it passes through the discharge space at the internal space of the chamber 131, thereby causing laser oscillation. A part of the oscillated laser light is transmitted through the output coupling mirror 147 as pulse laser light and travels to the beam splitter 163.

A part of the laser light having traveled to the beam splitter 163 is reflected by the beam splitter 163 and received by the optical sensor 165. The optical sensor 165 measures the energy E of the received laser light, and outputs a signal indicating the energy E to the laser device processor 190. The laser device processor 190 controls the charge voltage so that the difference ΔE between the energy E and the target energy Et falls within the allowable range, and after the difference ΔE falls within the allowable range, the laser device processor 190 transmits, to the exposure apparatus processor 230, the reception preparation completion signal indicating that reception preparation of the light emission trigger Tr is completed.

Upon receiving the reception preparation completion signal, the exposure apparatus processor 230 transmits the light emission trigger Tr to the laser device processor 190. When the laser device processor 190 opens the shutter 170 in synchronization with the reception of the light emission trigger Tr, the laser light having passed through the shutter 170 enters the exposure apparatus 200. The laser light is, for example, pulse laser light having a center wavelength of 193 nm.

### 2.3 Problem

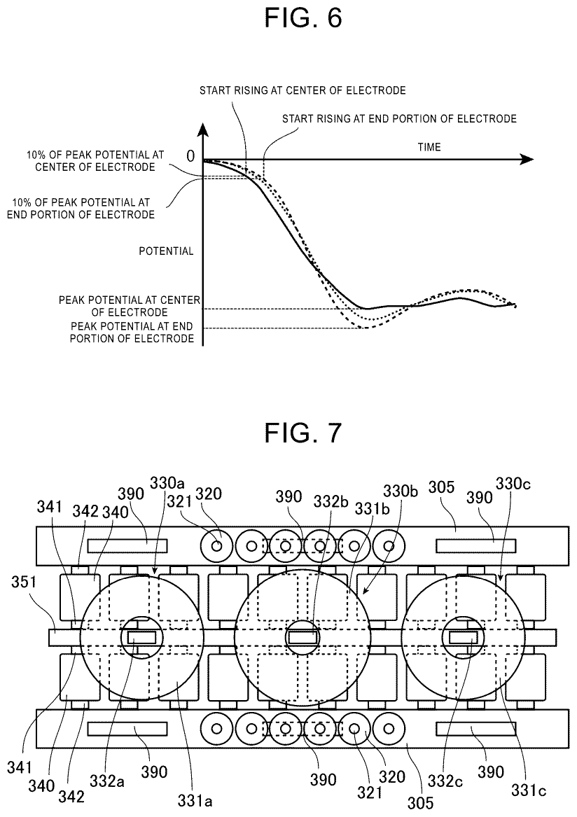

FIG. 6 is a graph showing temporal changes in the potential of the electrode 133b. In FIG. 6, a solid line indicates a potential at the center of the electrode 133b in the longitudinal direction, a broken line indicates a potential at the end portion of the electrode 133b in the longitudinal direction, and a dotted line indicates a potential at the middle of the electrode 133b between the center and the end portion in the longitudinal direction. Here, FIG. 6 shows the potentials when discharge is not occurring between the electrode 133b and the electrode 133a. As shown in FIG. 6, it can be seen that the potential rises earlier at the center of the electrode 133b than at the end portion of the electrode 133b. Here, as the rising timing of the potential, the timing corresponding to 10% of the peak potential is shown. It can also be seen that the potential peaks differ between the center of the electrode 133b in the longitudinal direction and the end portion of the electrode 133b in the longitudinal direction. The reason is as follows. That is, since the peaking capacitors 340 are arranged along the predetermined direction that is the longitudinal direction of the electrode 133b as described above, in the gas laser device 100 of the comparative example, the electric path from the magnetic switch 330 to the peaking capacitor 340 located near the center of the electrode 133b in the predetermined direction and the electric path from the magnetic switch 330 to the peaking capacitor 340 located near the end portion of the electrode 133b in the predetermined direction differ from each other. Accordingly, depending on the location of the peaking capacitor 340, there is a difference in the floating inductance due to the electric path from the capacitor 320 to the peaking capacitor 340 via the connection plate 310, the conductor 332, and the connection plate 351. The difference in the floating inductance due to the electric path causes a deviation in the timing of charging of the peaking capacitor 340 and the like, and a difference in the temporal change in the potential is caused depending on the location of the electrode 133b in the longitudinal direction.

When a difference in the potential of the electrode 133b occurs in the longitudinal direction as described above, uneven main discharge occurs between the electrode 133a and the electrode 133b, and the energy efficiency of the laser light output from the gas laser device 100 may be decreased. It is possible to output laser light satisfying the performance required from the exposure apparatus 200 in this state, but there is a concern that the wear of the electrodes 133a, 133b is accelerated. Accordingly, there is a possibility that the maintenance cost of the gas laser device 100 increases.

Therefore, in the following embodiments, the gas laser device 100 capable of suppressing uneven discharge between the electrode 133a and the electrode 133b is exemplified.

### 3. Description of Gas Laser Device of First Embodiment

Next, the gas laser device of a first embodiment will be described. Any component same as that described above is denoted by an identical reference sign, and duplicate description thereof is omitted unless specific description is needed. Further, in some drawings, a part of a member may be omitted or simplified for easy viewing.

### 3.1 Configuration

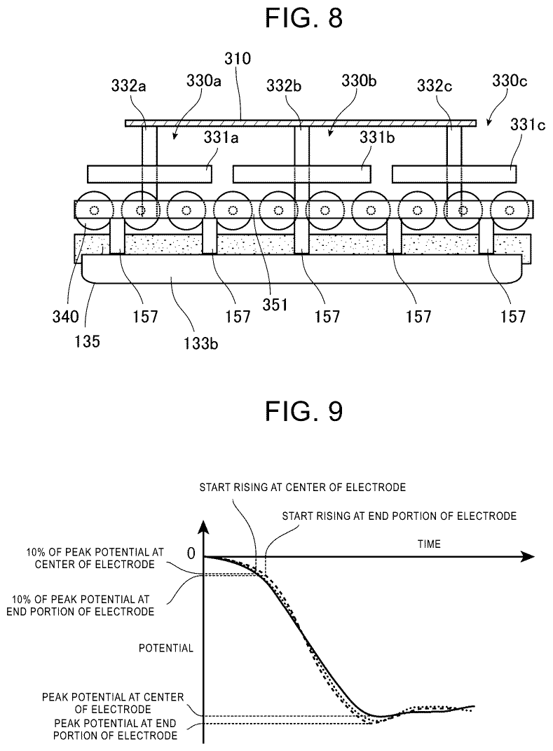

FIG. 7 is a view showing the configuration of a part of the circuit of the present embodiment in a similar manner as in FIG. 4. FIG. 8 is a view showing the configuration from the electrode 133b to the connection plate 310 of the present embodiment from a same viewpoint as in FIG. 2. As shown in FIGS. 7 and 8, the gas laser device 100 of the present embodiment differs from the gas laser device 100 of the comparative embodiment in including a first magnetic switch 330a, a second magnetic switch 330b, and a third magnetic switch 330c.

The first magnetic switch 330a, the second magnetic switch 330b, and the third magnetic switch 330c are arranged in this order in the predetermined direction that is the longitudinal direction of the electrode 133b. The second magnetic switch 330b is arranged closer to the center of the electrode 133b in the predetermined direction than the first magnetic switch 330a and the third magnetic switch 330c. In the present embodiment, the second magnetic switch 330b is arranged at the center of the electrode 133b in the predetermined direction. The first magnetic switch 330a and the third magnetic switch 330c are arranged at position symmetrical to each other with respect to the center of the electrode 133b in the predetermined direction.

In the present embodiment, the first magnetic switch 330a includes a first core 331a and a first conductor 332a, the second magnetic switch 330b includes a second core 331b and a second conductor 332b, and the third magnetic switch 330c includes a third core 331c and a third conductor 332c. Similarly to the configuration of the magnetic switch 330 of the comparative example, the first conductor 332a is inserted into the first core 331a, the second conductor 332b is inserted into the second core 331b, and the third conductor 332c is inserted into the third core 331c.

Each of the first conductor 332a, the second conductor 332b, and the third conductor 332c has a similar configuration as the conductor 332 of the magnetic switch 330 of the comparative example. Further, one end of each of the first conductor 332a, the second conductor 332b, and the third conductor 332c is electrically connected to the connection plate 310 in a similar manner as the one end of the conductor 332 of the comparative example. Further, the other end of each of the first conductor 332a, the second conductor 332b, and the third conductor 332c is electrically connected to the connection plate 351 in a similar manner as the other end of the conductor 332 of the comparative example. Therefore, the first magnetic switch 330a, the second magnetic switch 330b, and the third magnetic switch 330c are electrically connected to the electrode 133b and the terminals 341, on one side, of the plurality of peaking capacitors 340, and are connected in parallel to each other. The other end of the second conductor 332b is electrically connected to the connection plate 351 at a position closer to the center of the electrode 133b in the predetermined direction than the other end of the first conductor 332a and the other end of the third conductor 332c. In the present embodiment, the second conductor 332b s electrically connected to the connection plate 351 at the center of the electrode 133b in the predetermined direction, and the first conductor 332a and the third conductor 332c are electrically connected to the connection plate 351 at positions symmetrical to each other with respect to the center of the electrode 133b in the predetermined direction.

The first core 331a, the second core 331b, and the third core 331c have substantially the same configuration as the core 331 of the magnetic switch 330 of the comparative example, and are made of the same material as the core 331 of the magnetic switch 330 of the comparative example, and the first core 331a, the second core 331b, and the third core 331c are made of the same material. However, the cross-sectional area of each of the first core 331a and the third core 331c differs from the cross-sectional area of the second core 331b. In the following description, the “cross-sectional area” in a case in which a rotationally symmetric ring-shaped core is assumed refers to a cross-sectional area of a cross section including the rotation axis of rotational symmetry. In the present embodiment, the inner diameter of each of the first core 331a and the third core 331c is larger than the inner diameter of the second core 331b, and the outer diameter of each of the first core 331a and the third core 331c is smaller than the outer diameter of the second core 331b. Therefore, the cross-sectional area of each of the first core 331a and the third core 331c is smaller than the cross-sectional area of the second core 331b. Therefore, when the first core 331a, the second core 331b, and the third core 331c are made of the same material as in the present embodiment, the amount of change in the magnetic flux of the first core 331a from the OFF state to the ON state of the first magnetic switch 330a and the amount of change in the magnetic flux of the third core 331c from the OFF state to the ON state of the third magnetic switch 330c are smaller than the amount of change in the magnetic flux of the second core 331b from the OFF state to the ON state of the second magnetic switch 330b, respectively. Therefore, a Vt product of each of the first magnetic switch 330a and the third magnetic switch 330c is smaller than the Vt product of the second magnetic switch 330b. Here, it is preferable that the Vt product of each of the first magnetic switch 330a and the third magnetic switch 330c is 85% or more of the Vt product of the second magnetic switch 330b. In the present embodiment, the first core 331a and the third core 331c have the same configuration. Therefore, the cross-sectional area of the first core 331a and the cross-sectional area of the third core 331c are equal to each other, and the amount of change in the magnetic flux of the first core 331a from the OFF state to the ON state of the first magnetic switch 330a and the amount of change in the magnetic flux of the third core 331c from the OFF state to the ON state of the third magnetic switch 330c are equal to each other. Therefore, the Vt product of the first magnetic switch 330a and the Vt product of the third magnetic switch 330c are equal to each other.

### 3.2 Operation

In the present embodiment, in a similar manner as in the comparative example, the laser device processor 190 drives the charger 141 and turns ON the switch 301. Accordingly, the current from the charger 141 flows to the capacitor 320 via the connection plate 310, and the capacitor 320 is charged. The current from the charger 141 also tends to flow to the first conductor 332a, the second conductor 332b, and the third conductor 332c via the connection plate 310. Then, when the magnetic flux densities of the first core 331a, the second core 331b, and the third core 331c become close to saturation, the change in the magnetic flux density of each thereof becomes small, and the current flows to the first conductor 332a, the second conductor 332b, and the third conductor 332c. Thus, the current from the charger 141 and the capacitor 320 is charged to the peaking capacitor 340 via the first conductor 332a, the second conductor 332b, the third conductor 332c, and the connection plate 351. Thereafter, in a similar manner as in the comparative example, a pulse high voltage is applied to the electrode 133b in a short time. A high voltage is also applied between the preionization inner electrode 183 and the preionization outer electrode 185 in a similar manner as in the comparative example. When a high voltage is applied between the electrode 133a and the electrode 133b, main discharge occurs between the electrode 133a and the electrode 133b in a similar manner as in the comparative example, and the laser light is output from the gas laser device 100.

### 3.3 Effect

FIG. 9 is a graph showing, in a similar manner as in FIG. 6, temporal changes in the potential of the electrode 133b when the Vt products of the first magnetic switch 330a, the second magnetic switch 330b, and the third magnetic switch 330c are the same as each other in the present embodiment. Here, the electric path from the capacitor 320, via the connection plate 310, the first magnetic switch 330a, and the connection plate 351, to the peaking capacitor 340 located near the end portion of the electrode 133b on a side close to the first magnetic switch 330a in the predetermined direction is referred to as a first path. Further, the electric path from the capacitor 320, via the connection plate 310, the second magnetic switch 330b, and the connection plate 351, to the peaking capacitor 340 located near the center of the electrode 133b in the predetermined direction is referred to as a second path. Here, the electric path from the capacitor 320, via the connection plate 310, the third magnetic switch 330c, and the connection plate 351, to the peaking capacitor 340 located near the end portion of the electrode 133b on a side close to the third magnetic switch 330c in the predetermined direction is referred to as a third path. In this case, the difference between the floating inductance due to the second path and the floating inductance due to each of the first path and the third path is smaller than the difference, in the comparative example, between the floating inductance due to the electric path from the magnetic switch 330 to the peaking capacitor 340 located near the center of the electrode 133b and the floating inductance due to the electric path from the magnetic switch 330 to the peaking capacitor 340 located near the end portion of the electrode 133b. Therefore, as shown in FIG. 9, as compared with the comparative example shown in FIG. 6, the difference between the rising timings of the potential and the difference between the peaks of the potential is small between the center and the end portion of the electrode 133b in the longitudinal direction.

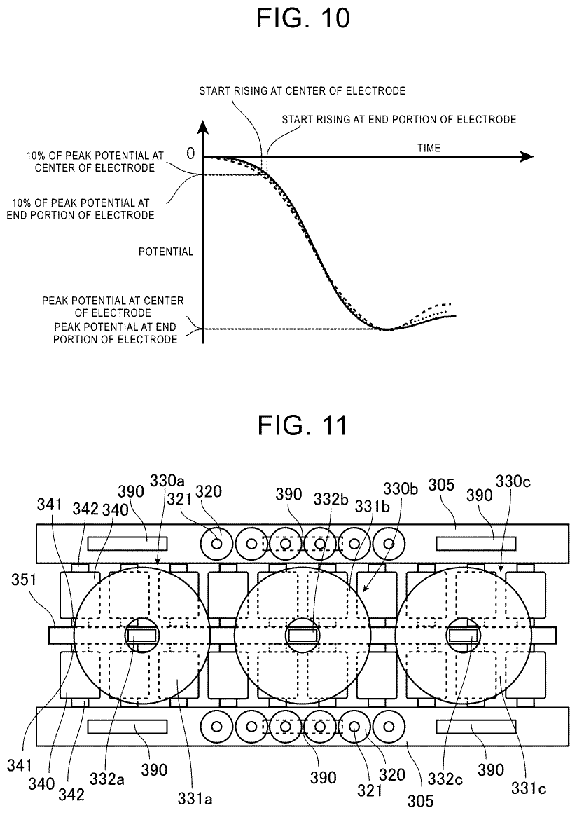

FIG. 10 is a graph showing temporal changes in the potential of the electrode 133b of the present embodiment in a similar manner as in FIG. 6. In FIG. 10, as described above, the Vt product of each of the first magnetic switch 330a and the third magnetic switch 330c is smaller than the Vt product of the second magnetic switch 330b. Therefore, the magnetic flux density of each of the first core 331a and the third core 331c becomes close to saturation earlier than the magnetic flux density of the second core 331b. Therefore, a current starts to flow to the first conductor 332a and the third conductor 332c at a timing earlier than to the second conductor 332b. Therefore, as shown in FIG. 10, as compared with FIG. 9, the difference in the rising timings of the potential between the center and the end portion of the electrode 133b in the longitudinal direction can be set smaller, and the difference in the peaks of the potential between the center and the end portion of the electrode 133b in the longitudinal direction can be set smaller.

As described above, the gas laser device 100 of the present embodiment includes the first magnetic switch 330a and the second magnetic switch 330b electrically connected to the electrode 133b and the terminal 341, on one side, of the plurality of peaking capacitors 340 and electrically connected in parallel to each other. The second magnetic switch 330b is arranged closer to the center of the electrode 133b in the predetermined direction than the first magnetic switch 330a, and the Vt product of the first magnetic switch 330a is smaller than the Vt product of the second magnetic switch 330b. Therefore, as compared with the gas laser device 100 of the comparative example in which the first magnetic switch 330a is not provided, the difference in the potential of the electrode 133b in the longitudinal direction at the same time can be reduced. Therefore, uneven discharge between the electrode 133a and the electrode 133b can be suppressed, and a decrease in the energy efficiency of the laser and the wear of the electrodes 133a, 133b can be suppressed.

Further, in the present embodiment, the third magnetic switch 330c is included. The third magnetic switch 330c is electrically connected to the electrode 133b and the terminals 341, on one side, of the plurality of peaking capacitors 340, and is electrically connected in parallel to the first magnetic switch 330a and the second magnetic switch 330b. Further, the third magnetic switch 330c is arranged on the side opposite to the first magnetic switch 330a in the predetermined direction with respect to the second magnetic switch 330b, and the second magnetic switch 330b is arranged closer to the e center of 133b the electrode in the predetermined direction than the third magnetic switch 330c. Therefore, the difference in the potential of the electrode 133b in the longitudinal direction at the same time can be reduced as compared with the case in which the third magnetic switch 330c is not included. Here, in the present embodiment, the gas laser device 100 may not include the third magnetic switch 330c. However, from the viewpoint of further suppressing occurrence of uneven discharge between the electrode 133b and the electrode 133a by reducing the difference in the potential of the electrode 133b in the longitudinal direction at the same time, it is preferable that the gas laser device 100 includes the third magnetic switch 330c. The above applies similarly to second to fifth embodiments described later.

Here, in the present embodiment, the second magnetic switch 330b is arranged at the center of the electrode 133b in the predetermined direction. However, it may be deviated from the center. Further, in the present embodiment, the first magnetic switch 330a and the third magnetic switch 330c are arranged at positions symmetrical to each other with respect to the center of the electrode 133b in the predetermined direction. However, they may be arranged at positions asymmetrical to each other. Further, in the present embodiment, the Vt product of the first magnetic switch 33a and the Vt product of the third magnetic switch 330c has been described as being equal to each other, but the Vt products of the both may be different from each other. Therefore, the cross-sectional area of the first core 331a and the cross-sectional area of the third core 331c may be different from each other. Further, it has been described that the inner diameter of each of the first core 331a and the third core 331c is larger than the inner diameter of the second core 331b, and the outer diameter of each of the first core 331a and the third core 331c is smaller than the outer diameter of the second core 331b. However, if the cross-sectional area of each of the first core 331a and the third core 331c is smaller than the cross-sectional area of the second core 331b, the inner diameter of each of the first core 331a and the third core 331c may be equal to the inner diameter of the second core 331b, and the outer diameter of each of the first core 331a and the third core 331c may be equal to the outer diameter of the second core 331b.

### 4. Description of Gas Laser Device of Second Embodiment

Next, the gas laser device of a second embodiment will be described. Any component same as that described above is denoted by an identical reference sign, and duplicate description thereof is omitted unless specific description is needed.

### 4.1 Configuration

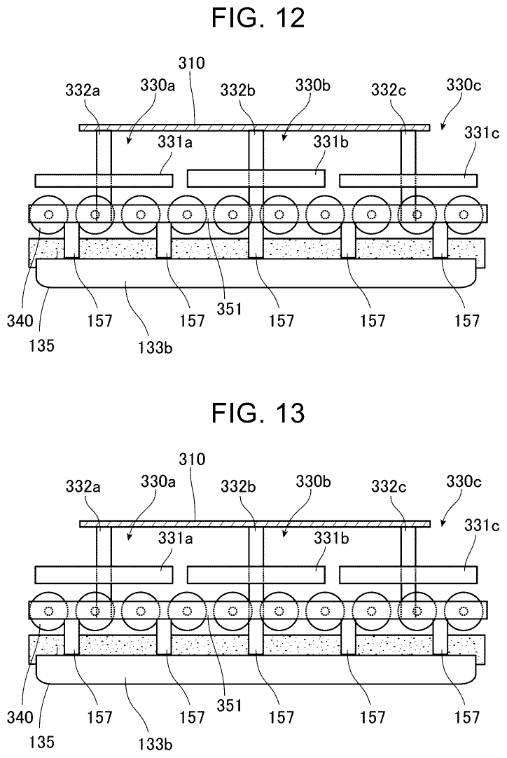

FIG. 11 is a view showing the configuration of a part of the circuit of the present embodiment in a similar manner as in FIG. 4. FIG. 12 is a view showing the configuration from the electrode 133b to the connection plate 310 of the present embodiment from a same viewpoint as in FIG. 2.

As shown in FIGS. 11 and 12, similarly to the first embodiment, the gas laser device of the present embodiment includes the first magnetic switch 330a, the second magnetic switch 330b, and the third magnetic switch 330c. However, the gas laser device of the present embodiment differs from the gas laser device of the first embodiment in that the inner diameter and the outer diameter are the same among the first core 331a, the second core 331b, and the third core 331c, and the thickness of each of the first core 331a and the third core 331c is smaller than the thickness of the second core 331b. In the following description, the “thickness” in a case in which a rotationally symmetric ring-shaped core is assumed refers to the length of the core in a direction parallel to the rotation axis of rotational symmetry. Therefore, similarly to the first embodiment, the cross-sectional area of each of the first core 331a and the third core 331c is smaller than the cross-sectional area of the second core 331b, and the Vt product of each of the first magnetic switch 330a and the third magnetic switch 330c is smaller than the Vt product of the second magnetic switch 330b.

The thickness of the first core 331a and the thickness of the third core 331c are preferably equal to each other, but may be different from each other.

### 4.2 Effect

In the gas laser device of the present embodiment as well, the difference in the potential of the electrode 133b in the longitudinal direction at the same time can be reduced in a similar manner as in the gas laser device 100 of the first embodiment. Therefore, according to the gas laser device of the present embodiment, uneven discharge between the electrode 133a and the electrode 133b can be suppressed, and a decrease in the energy efficiency of the laser and the wear of the electrodes 133a, 133b can be suppressed.

Further, in the present embodiment, the cross-sectional area of each of the first core 331a and the third core 331c is set smaller than the cross-sectional area of the second core 331b by setting the thickness of each of the first core 331a and the third core 331c to be smaller than the thickness of the second core 331b. In this case, the core can be easily manufactured as compared with the case in which the cross-sectional area of the core is changed by changing the inner diameter and the outer diameter of the core as in the first embodiment.

Here, in the present embodiment, if the cross-sectional area of each of the first core 331a and the third core 331c is smaller than the cross-sectional area of the second core 331b, the inner diameter and the outer diameter may be different among the first core 331a, the second core 331b, and the third core 331c.

### 5. Description of Gas Laser Device of Third Embodiment

Next, the gas laser device of a third embodiment will be described. Any component same as that described above is denoted by an identical reference sign, and duplicate description thereof is omitted unless specific description is needed.

### 5.1 Configuration

FIG. 13 is a view showing the configuration from the electrode 133b to the connection plate 310 of the present embodiment from a same viewpoint as in FIG. 2. Here, when the configuration of a part of the circuit in the present embodiment is shown in a similar manner as in FIG. 4, a view similar to FIG. 11 is obtained.

As shown in FIG. 13, the gas laser device of the present embodiment includes the first magnetic switch 330a, the second magnetic switch 330b, and the third magnetic switch 330c at the same positions as those of the first embodiment. However, the gas laser device of the present embodiment differs from the gas laser device of the first embodiment in that the cross-sectional areas of the first core 331a, the second core 331b, and the third core 331c are equal to each other.

Further, in the present embodiment, the magnetic material used for the first core 331a and the third core 331c is a magnetic material having a smaller amount of change in the magnetic flux density than the magnetic material used for the second core 331b. For example, in general, the amount of change in the magnetic flux density of a silicon steel is larger than the amount of change in the magnetic flux density of an iron-based ultrafine particle alloy. Further, for example, in general, the amount of change in the magnetic flux density of an iron-based alloy is larger than the amount of change in the magnetic flux density of Permalloy (registered trademark), the amount of change in the magnetic flux density of Permalloy is larger than the amount of change in the magnetic flux density of a cobalt-based alloy, and the amount of change in the magnetic flux density of a cobalt-based alloy is larger than the amount of change in the magnetic flux density of an Mn—Zn-based ferrite. Therefore, for example, a cobalt-based alloy or an Mn—Zn-based ferrite is used as the magnetic material for the first core 331a and the third core 331c, and Permalloy is used as the magnetic material for the second core 331b. With such a configuration, the Vt product of each of the first magnetic switch 330a and the third magnetic switch 330c can be set smaller than the Vt product of the second magnetic switch 330b.

Here, it is preferable that the magnetic material used for the first core 331a and the magnetic material used for the third core 331c are the same, but may be different from each other.

### 5.2 Effect

In the gas laser device of the present embodiment as well, the difference in the potential of the electrode 133b in the longitudinal direction at the same time can be reduced in a similar manner as in the gas laser device 100 of the first embodiment. Therefore, according to the gas laser device of the present embodiment, uneven discharge between the electrode 133a and the electrode 133b can be suppressed, and a decrease in the energy efficiency of the laser and the wear of the electrodes 133a, 133b can be suppressed.

In the present embodiment, the first core 331a, the second core 331b, and the third core 331c may have the same size. Therefore, peripheral components of the first core 331a, the second core 331b, and the third core 331c can be used in common. For example, when a winding is required, each core can adopt the wiring having a generally common length. Since the winding needs to be wound in accordance with the size of the core in the radial direction, when the winding can be used in common for a plurality of cores, component management and assembly can be facilitated. As a result, quality control is facilitated and productivity is improved. Here, in the present embodiment, if the Vt product of each of the first magnetic switch 330a and the third magnetic switch 330c is smaller than the Vt product of the second magnetic switch 330b, the inner diameter and the outer diameter may be different among the first core 331a, the second core 331b, and the third core 331c.

### 6. Description of Gas Laser Device of Fourth Embodiment

Next, the gas laser device of a fourth embodiment will be described. Any component same as that described above is denoted by an identical reference sign, and duplicate description thereof is omitted unless specific description is needed.

### 6.1 Configuration

The gas laser device of the present embodiment includes the first magnetic switch 330a, the second magnetic switch 330b, and the third magnetic switch 330c, and similarly to the gas laser device of the third embodiment, the cross-sectional areas of the first core 331a, the second core 331b, and the third core 331c are the same. Therefore, when showing the configuration of the present embodiment from the electrode 133b to the connection plate 310 from a same viewpoint as in FIG. 2, a view similar to FIG. 13 is obtained, and when showing the configuration of a part of the circuit of the present embodiment in a similar manner as in FIG. 4, a view similar to FIG. 11 is obtained. However, in the gas laser device of the present embodiment, the lamination factor of the magnetic material in each of the first core 331a and the third core 331c is lower than the lamination factor of the magnetic material in the second core 331b.

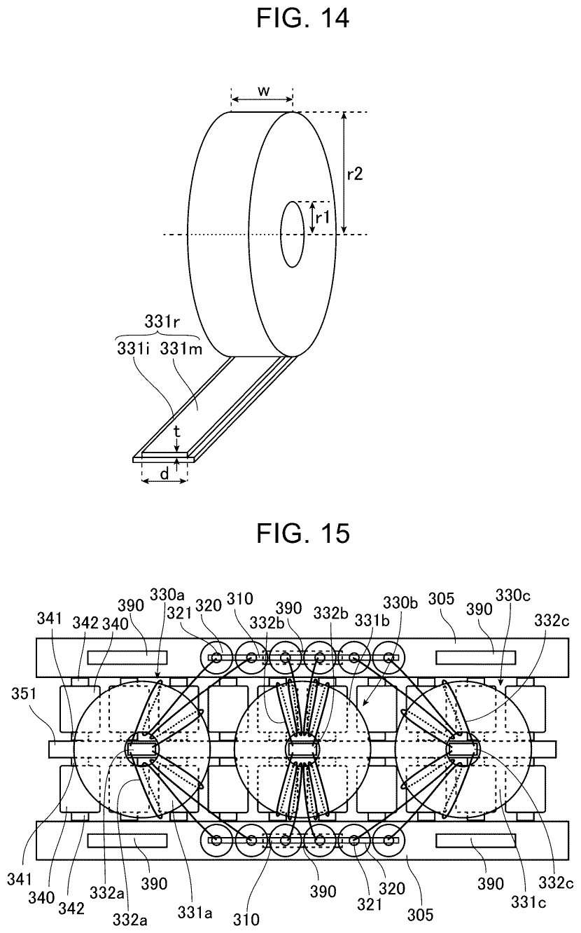

FIG. 14 is a view showing a core serving as each of the first core 331a, the second core 331b, and the third core 331c of the present embodiment. As shown in FIG. 14, in the present embodiment, each core is formed by winding a ribbon 331r in which a thin-plate-shaped magnetic material 331m is laminated on a thin-plate-shaped insulator 331i. FIG. 14 shows a state in which a part of the ribbon 331r is drawn out.

Here, the width of the magnetic material 331m is defined as d, and the thickness thereof is defined as t. The length of the ribbon 331r is defined as L. Further, the thickness of the core is defined as w, the inner radius of the core is defined as r1, and the outer radius of the core is defined as r2. In this case, a lamination factor R of the magnetic material 331m in the core is expressed by the following expression.

$$R = d \times t \times L / ( w \times ( r {2}^{2} - r {1}^{2} ) \times \prod )$$

Therefore, by setting the width d and the thickness t of the magnetic material 331m to be different between the second core 331b and the first and third cores 331a, 331c, the lamination factor R of the magnetic material 331m in each of the first core 331a and the third core 331c is set lower than the lamination factor R of the magnetic material 331m in the second core 331b. For example, the thickness t of the magnetic material 331m is set to be the same among the first core 331a, the second core 331b, and the third core 331c, and the width d of the magnetic material 331m of each of the first core 331a and the third core 331c is set smaller than the width d of the magnetic material 331m of the second core 331b. Alternatively, for example, the width d of the magnetic material 331m is set to be the same among the first core 331a, the second core 331b, and the third core 331c, and the thickness t of the magnetic material 331m of each of the first core 331a and the third core 331c is set smaller than the thickness t of the magnetic material 331m of the second core 331b.

By setting the lamination factor R of the magnetic material 331m in each of the first core 331a and the third core 331c lower than the lamination factor R of the magnetic material 331m in the second core 331b, the Vt product of each of the first magnetic switch 330a and third magnetic switch 330c can be set smaller than the Vt product of the second magnetic switch 330b.

### 6.2 Effect

In the gas laser device 100 of the present embodiment as well, the difference in the potential of the electrode 133b in the longitudinal direction at the same time can be reduced in a similar manner as in the gas laser device 100 of the first embodiment. Therefore, according to the gas laser device 100 of the present embodiment, uneven discharge between the electrode 133a and the electrode 133b can be suppressed, and a decrease in the energy efficiency of the laser and the wear of the electrodes 133a, 133b can be suppressed.

Here, in the present embodiment, if the Vt product of each of the first magnetic switch 330a and the third magnetic switch 330c is smaller than the Vt product of the second magnetic switch 330b, the inner diameter and the outer diameter may be different among the first core 331a, the second core 331b, and the third core 331c. Further, the lamination factors R in the first core 331a and the third core 331c may be different from each other.

### 7. Description of Gas Laser Device of Fifth Embodiment

Next, the gas laser device of a fifth embodiment will be described. Any component same as that described above is denoted by an identical reference sign, and duplicate description thereof is omitted unless specific description is needed.

### 7.1 Configuration

FIG. 15 is a view showing the configuration of a part of the circuit of the present embodiment in a similar manner as in FIG. 4. As shown in FIG. 15, the gas laser device of the present embodiment includes the first magnetic switch 330a, the second magnetic switch 330b, and the third magnetic switch 330c, and similarly to the gas laser device of the third embodiment, the cross-sectional areas of the first core 331a, the second core 331b, and the third core 331c are the same. In the present embodiment, the first conductor 332a of the first magnetic switch 330a is wound around the first core 331a, the second conductor 332b of the second magnetic switch 330b is wound around the second core 331b, and the third conductor 332c of the third magnetic switch 330c is wound around the third core 331c. Each of the number of turns of the first conductor 332a and the third conductor 332c is smaller than the number of turns of the second conductor 332b.

Here, when the voltage applied to the magnetic switch is V, the pulse width is t, the amount of change in the magnetic flux density of the core is ΔB, the number of turns of the conductor is N, and the effective cross-sectional area of the core is Ae, the following expression is satisfied.

$$V \times t = Δ B \times N \times Ae$$

Therefore, the larger the number of turns is, the larger the Vt product of the magnetic switch is.

In the present embodiment, as described above, each of the number of turns of the first conductor 332a and the third conductor 332c is smaller than the number of turns of the second conductor 332b. Therefore, the Vt product of each of the first magnetic switch 330a and the third magnetic switch 330c is smaller than the Vt product of the second magnetic switch 330b.

### 7.2 Effect

In the gas laser device of the present embodiment as well, the difference in the potential of the electrode 133b in the longitudinal direction at the same time can be reduced in a similar manner as in the gas laser device 100 of the first embodiment. Therefore, according to the gas laser device of the present embodiment, uneven discharge between the electrode 133a and the electrode 133b can be suppressed, and a decrease in the energy efficiency of the laser and the wear of the electrodes 133a, 133b can be suppressed.

Further, in the present embodiment, by setting the number of turns of the conductor to be different between the second magnetic switch 330b and the first and third magnetic switches 330a, 330c, the Vt product of each of the first magnetic switch 330a and the third magnetic switch 330c can be set smaller than the Vt product of the second magnetic switch 330b. Therefore, the first core 331a, the second core 331b, and the third core 331c can be used in common, and the cost can be lowered.

Here, in the present embodiment, if the Vt product of each of the first magnetic switch 330a and the third magnetic switch 330c is smaller than the Vt product of the second magnetic switch 330b, the configuration may be different among the first core 331a, the second core 331b, and the third core 331c.

### 8. Description of Gas Laser Device of Sixth Embodiment

Next, the gas laser device of a sixth embodiment will be described. Any component same as that described above is denoted by an identical reference sign, and duplicate description thereof is omitted unless specific description is needed.

### 8.1 Configuration

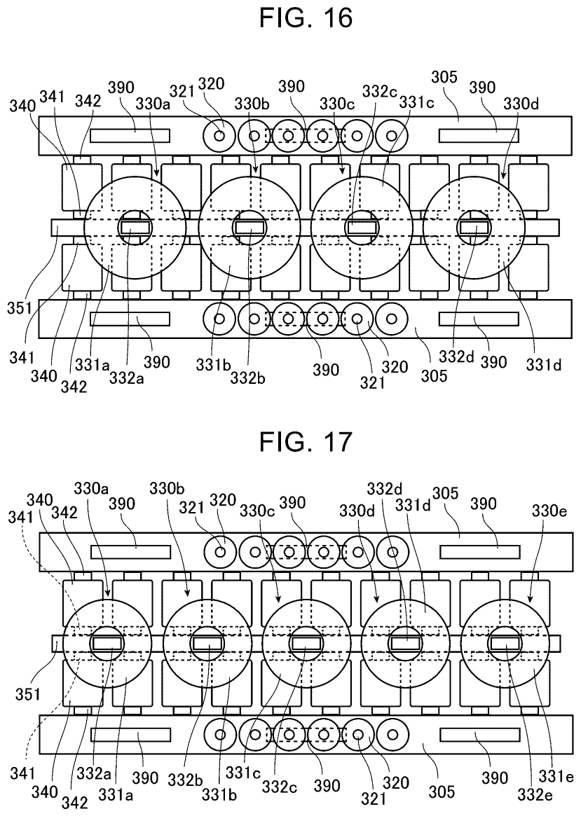

FIG. 16 is a view showing the configuration of a part of the circuit of the present embodiment in a similar manner as in FIG. 4. As shown in FIG. 16, the gas laser device of the present embodiment includes the first magnetic switch 330a, the second magnetic switch 330b, the third magnetic switch 330c, and a fourth magnetic switch 330d.

The fourth magnetic switch 330d includes a fourth core 331d and a fourth conductor 332d. The fourth conductor 332d is inserted into the fourth core 331d. The fourth core 331d has the same configuration as any one of the first core 331a to the third core 331c of the above-described embodiments, and the fourth conductor 332d has the same configuration as any one of the first conductor 332a to the third conductor 332c of the above-described embodiments. One end of the fourth conductor 332d is electrically connected to the connection plate 310, and the other end is electrically connected to the connection plate 351. Therefore, the first to the fourth magnetic switches 330a to 330d are electrically connected to the electrode 133b and the terminals 341, on one side, of the plurality of peaking capacitors 340, and are connected in parallel to each other.

The magnetic switches are arranged in the order of the first magnetic switch 330a, the second magnetic switch 330b, the third magnetic switch 330c, and the fourth magnetic switch 330d along the predetermined direction. In the present embodiment, similarly to the above-described embodiments, the second magnetic switch 330b is arranged closer to the center of the electrode 133b in the predetermined direction than the first magnetic switch 330a, and the Vt product of the first magnetic switch 330a is smaller than the Vt product of the second magnetic switch 330b. Further, in the present embodiment, the third magnetic switch 330c is arranged closer to the center of the electrode 133b in the predetermined direction than the fourth magnetic switch 330d, and the Vt product of the fourth magnetic switch 330d is smaller than the Vt product of the third magnetic switch 330c.

In the present embodiment, the second magnetic switch 330b and the third magnetic switch 330c are arranged at positions symmetrical to each other with respect to the center of the electrode 133b in the predetermined direction, and the first magnetic switch 330a and the fourth magnetic switch 330d are arranged at positions symmetrical to each other with respect to the center of the electrode 133b in the predetermined Further, in the present embodiment, the Vt product of the second magnetic switch 330b and the Vt product of the third magnetic switch 330c are equal to each other, and the Vt product of the first magnetic switch 330a and the Vt product of the fourth magnetic switch 330d are equal to each other.

As the method of setting the Vt products of the magnetic switches to be different from each other, the method of the first embodiment to the fifth embodiment can be used. Therefore, for example, by setting the cross-sectional area of each of the first core 331a and the fourth core 331d smaller than the cross-sectional area of each of the second core 331b and the third core 331c, the Vt product of each of the first magnetic switch 330a and the fourth magnetic switch 330d is set smaller than the Vt product of each of the second magnetic switch 330b and the third magnetic switch 330c.

### 8.2 Effect

According to the gas laser device of the present embodiment, the gas laser device includes four magnetic switches arranged along the predetermined direction, the Vt product of the first magnetic switch 330a is smaller than the Vt product of the second magnetic switch 330b, and the Vt product of the fourth magnetic switch 330d is smaller than the Vt product of the third magnetic switch 330c. Therefore, the difference in the potential of the electrode 133b in the longitudinal direction at the same time can be further reduced as compared with the above-described embodiments. Therefore, according to the gas laser device of the present embodiment, uneven discharge between the electrode 133a and the electrode 133b can be further suppressed, and a decrease in the energy efficiency of the laser and the wear of the electrodes 133a, 133b can be further suppressed.

Here, in the present embodiment, the first magnetic switch 330a and the fourth magnetic switch 330d may be arranged at positions asymmetrical to each other with respect to the center of the electrode 133b in the predetermined direction. Similarly, the second magnetic switch 330b and the third magnetic switch 330c may be arranged at positions asymmetrical to each other with respect to the center of the electrode 133b in the predetermined direction. Further, in the present embodiment, the Vt product of the first magnetic switch 330a and the Vt product of the fourth magnetic switch 330d may be different from each other, and the Vt product of the second magnetic switch 330b and the Vt product of the third magnetic switch 330c may be different from each other.

### 9. Description of Gas Laser Device of Seventh Embodiment

Next, the gas laser device of a seventh embodiment will be described. Any component same as that described above is denoted by an identical reference sign, and duplicate description thereof is omitted unless specific description is needed.

### 9.1 Configuration

FIG. 17 is a view showing the configuration of a part of the circuit of the present embodiment in a similar manner as in FIG. 4. As shown in FIG. 17, the gas laser device of the present embodiment includes the first magnetic switch 330a, the second magnetic switch 330b, the third magnetic switch 330c, the fourth magnetic switch 330d, and a fifth magnetic switch 330e.

The fifth magnetic switch 330e includes a fifth core 331e and a fifth conductor 332e. The fifth conductor 332e is inserted into the fifth core 331e. The fifth core 331e has the same configuration as any one of the first core 331a to the fourth core 331d of the above-described embodiments, and the fifth conductor 332e has the same configuration as any one of the first conductor 332a to the fourth conductor 332d of the above-described embodiments. One end of the fifth conductor 332e is electrically connected to the connection plate 310, and the other end is electrically connected to the connection plate 351. Therefore, the first to the fifth magnetic switches 330a to 330e are electrically connected to the electrode 133b and the terminals 341, on one side, of the plurality of peaking capacitors 340, and are connected in parallel to each other.

The magnetic switches are arranged in the order of the first magnetic switch 330a, the second magnetic switch 330b, the third magnetic switch 330c, the fourth magnetic switch 330d, and the fifth magnetic switch along the predetermined direction. In the present embodiment, similarly to the embodiments described above, the second magnetic switch 330b is arranged closer to the center of the electrode 133b in the predetermined direction than the first magnetic switch 330a, and the Vt product of the first magnetic switch 330a is smaller than the Vt product of the second magnetic switch 330b. Further, the fourth magnetic switch 330d is arranged closer to the center of the electrode 133b in the predetermined direction than the fifth magnetic switch 330e, and the Vt product of the fifth magnetic switch 330e is smaller than the Vt product of the fourth magnetic switch 330d. The third magnetic switch 330c is arranged closer to the center of the electrode 133b in the predetermined direction than the second magnetic switch 330b and the fourth magnetic switch 330d, and the Vt product of each of the second magnetic switch 330b and the fourth magnetic switch 330d is smaller than the Vt product of the third magnetic switch 330c.

In the present embodiment, the third magnetic switch 330c is arranged at the center of the electrode 133b in the predetermined direction. Further, the second magnetic switch 330b and the fourth magnetic switch 330d are arranged at positions symmetrical to each other with respect to the center of the electrode 133b in the predetermined direction, and the first magnetic switch 330a and the fifth magnetic switch 330e are arranged at positions symmetrical to each other with respect to the center of the electrode 133b in the predetermined direction. Further, in the present embodiment, the Vt product of the second magnetic switch 330b and the Vt product of the fourth magnetic switch 330d are equal to each other, and the Vt product of the first magnetic switch 330a and the Vt product of the fifth magnetic switch 330e are equal to each other.

As the method of setting the Vt products of the magnetic switches to be different from each other, similarly to the description of the sixth embodiment, the method of the first embodiment to the fifth embodiment can be used. Therefore, for example, the cross-sectional area of each of the first core 331a and the fifth core 331e is set smaller than the cross-sectional area of each of the second core 331b and the fourth core 331d, and the cross-sectional area of each of the second core 331b and the fourth core 331d is set smaller than the cross-sectional area of the third core 331c. Thus, the Vt product of each of the first magnetic switch 330a and the fifth magnetic switch 330e is set smaller than the Vt product of each of the second magnetic switch 330b and the fourth magnetic switch 330d, and the Vt product of each of the second magnetic switch 330b and the fourth magnetic switch 330d is set smaller than the Vt product of the third magnetic switch 330c.

### 9.2 Effect

According to the gas laser device of the present embodiment, the gas laser device includes five magnetic switches arranged along the predetermined direction. Then, the Vt product of the first magnetic switch 330a is smaller than the Vt product of the second magnetic switch 330b, the Vt product of the fifth magnetic switch 330e is smaller than the Vt product of the fourth magnetic switch 330d, and the Vt product of each of the second magnetic switch 330b and the fourth magnetic switch 330d is smaller than the Vt product of the third magnetic switch 330c. Therefore, the difference in the potential of the electrode 133b in the longitudinal direction at the same time can be further reduced as compared with the above-described embodiments. Therefore, according to the gas laser device of the present embodiment, uneven discharge between the electrode 133a and the electrode 133b can be further suppressed, and a decrease in the energy efficiency of the laser and the wear of the electrodes 133a, 133b can be further suppressed.

Here, in the present embodiment, the third magnetic switch 330c may be arranged at a position deviated from the center of the electrode 133b in the predetermined direction. Further, in the present embodiment, the first magnetic switch 330a and the fifth magnetic switch 330e may be arranged at positions asymmetrical to each other with respect to the center of the electrode 133b in the predetermined direction. Similarly, the second magnetic switch 330b and the fourth magnetic switch may 330d be arranged at positions asymmetrical to each other with respect to the center of the electrode 133b in the predetermined direction. Further, in the present embodiment, the Vt product of the first magnetic switch 330a and the Vt product of the fifth magnetic switch 330e may be different from each other, and the Vt product of the second magnetic switch 330b and the Vt product of the fourth magnetic switch 330d may be different from each other.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined. The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. A gas laser device comprising:
a chamber configured to enclose a laser gas as including a pair of discharge electrodes having a longitudinal direction oriented along a predetermined direction and facing each other with a space therebetween;
a plurality of capacitors arranged along the predetermined direction, each of the capacitors having one terminal electrically connected to one of the discharge electrodes and the other terminal electrically connected to the other of the discharge electrodes; and
a first magnetic switch and a second magnetic switch each electrically connected to the one discharge electrode and the one terminal of each of the capacitors and electrically connected to each other in parallel,
the second magnetic switch being arranged closer to a center of the one discharge electrode in the predetermined direction than the first magnetic switch, and
a Vt product of the first magnetic switch being smaller than a Vt product of the second magnetic switch.

2. The gas laser device according to claim 1,
wherein the first magnetic switch includes a ring-shaped first core,
the second magnetic switch includes a ring-shaped second core, and
an amount of change in magnetic flux of the first core is smaller than an amount of change in magnetic flux of the second core.

3. The gas laser device according to claim 2,
wherein a cross-sectional area of the first core is smaller than a cross-sectional area of the second core.

4. The gas laser device according to claim 3,
wherein an inner diameter of the first core is larger than an inner diameter of the second core.

5. The gas laser device according to claim 3,
wherein an outer diameter of the first core is smaller than an outer diameter of the second core.

6. The gas laser device according to claim 3,
wherein a thickness of the first core is smaller than a thickness of the second core.

7. The gas laser device according to claim 2,
wherein a lamination factor of a magnetic material in the first core is lower than a lamination factor of a magnetic material in the second core.

8. The gas laser device according to claim 2,
wherein a magnetic material of the first core has a smaller amount of change in magnetic flux than a magnetic material of the second core.

9. The gas laser device according to claim 1,
wherein the first magnetic switch includes a ring-shaped first core, and a first conductor electrically connected to the one discharge electrode and the one terminal of each of the capacitors and wound around the first core,
the second magnetic switch includes a ring-shaped second core, and a second conductor electrically connected to the one discharge electrode and the one terminal of each of the capacitors and wound around the second core, and
a number of turns of the first conductor is smaller than a number of turns of the second conductor.

10. The gas laser device according to claim 1,
wherein the Vt product of the first magnetic switch is 85% or more of the Vt product of the second magnetic switch.

11. The gas laser device according to claim 1,
further comprising a third magnetic switch electrically connected to the one discharge electrode and the one terminal of each of the capacitors and electrically connected to the first magnetic switch and the second magnetic switch in parallel,
wherein the third magnetic switch is arranged on a side opposite to the first magnetic switch in the predetermined direction with respect to the second magnetic switch,
the second magnetic switch is arranged closer to the center of the one discharge electrode in the predetermined direction than the third magnetic switch, and
a Vt product of the third magnetic switch is smaller than the Vt product of the second magnetic switch.

12. The gas laser device according to claim 11,
wherein the second magnetic switch is arranged at the center of the one discharge electrode in the predetermined direction.

13. The gas laser device according to claim 11,
wherein the first magnetic switch and the third magnetic switch are arranged at positions symmetrical to each other with respect to the center of the one discharge electrode in the predetermined direction, and
the Vt product of the first magnetic switch and the Vt product of the third magnetic switch are equal to each other.

14. The gas laser device according to claim 1,
further comprising a third magnetic switch and a fourth magnetic switch each electrically connected to the one discharge electrode and the one terminal of each of the capacitors and each electrically connected to the first magnetic switch and the second magnetic switch in parallel,
wherein the magnetic switches are arranged in the order of the first magnetic switch, the second magnetic switch, the third magnetic switch, and the fourth magnetic switch along the predetermined direction,
the third magnetic switch is arranged closer to the center of the one discharge electrode in the predetermined direction than the fourth magnetic switch, and
a Vt product of the fourth magnetic switch is smaller than a Vt product of the third magnetic switch.

15. The gas laser device according to claim 14,
wherein the second magnetic switch and the third magnetic switch are arranged at positions symmetrical to each other with respect to the center of the one discharge electrode in the predetermined direction, and
the Vt product of the second magnetic switch and the Vt product of the third magnetic switch are equal to each other.

16. The gas laser device according to claim 1,
further comprising a third magnetic switch, a fourth magnetic and switch, a fifth magnetic switch each electrically connected to the one discharge electrode and the one terminal of each of the capacitors and each electrically connected to the first magnetic switch and the second magnetic switch in parallel,
wherein the magnetic switches are arranged in the order of the first magnetic switch, the second magnetic switch, the third magnetic switch, the fourth magnetic switch, and the fifth magnetic switch along the predetermined direction,
the third magnetic switch is arranged closer to the center of the one discharge electrode in the predetermined direction than the second magnetic switch and the fourth magnetic switch,
the Vt product of the second magnetic switch is smaller than a Vt product of the third magnetic switch,
a Vt product of the fourth magnetic switch is smaller than the Vt product of the third magnetic switch, and
a Vt product of the fifth magnetic switch is smaller than the Vt product of the fourth magnetic switch.

17. The gas laser device according to claim 16,
wherein the third magnetic switch is arranged at the center of the one discharge electrode in the predetermined direction.

18. An electronic device manufacturing method, comprising:
generating laser light using a gas laser device;
outputting the laser light to an exposure apparatus; and
exposing a photosensitive substrate to the laser light in the exposure apparatus to manufacture an electronic device,
the gas laser device including:
a chamber configured to enclose a laser gas as including a pair a of discharge electrodes having longitudinal direction oriented along a predetermined direction and facing each other with a space therebetween;
a plurality of capacitors arranged along the predetermined direction, each of the capacitors having one terminal electrically connected to one of the discharge electrodes and the other terminal electrically connected to the other of the discharge electrodes; and
a first magnetic switch and a second magnetic switch each electrically connected to the one discharge electrode and the one terminal of each of the capacitors and electrically connected to each other in parallel,
the second magnetic switch being arranged closer to a center of the one discharge electrode in the predetermined direction than the first magnetic switch, and
a Vt product of the first magnetic switch being smaller than a Vt product of the second magnetic switch.
